(19) United States
(12) Patent Application Publication
(10) Pub. No.: US 2023/0054348 A1
(43) Pub. Date: Feb. 23, 2023

(54) SYSTEM FOR WRAPPING ELONGATED OBJECT

(71) Applicant: Certoplast Technische Klebebaender GmbH, (US)

(72) Inventors: Timo LEERMANN, Wuppertal (DE); Peter RAMBUSCH, Wuppertal (DE)

(21) Appl. No.: 17/961,078

(22) Filed: Oct. 6, 2022

Related U.S. Application Data
(62) Division of application No. 16/647,903, filed on Mar. 17, 2020.

(51) Int. Cl. C09J 7/21; C09J 7/35; C09J 7/38

(52) U.S. Cl. CPC C09J 7/21; C09J 7/35; C09J 7/38; C09J 2301/312; C09J 2301/124; C09J 2301/204; C09J 2203/302; C09J 2400/26; C09J 2400/263; C09J 2467/006; C09J 2477/006

(57) ABSTRACT

A support tape extends longitudinally along an elongated object, is wrapped around the object, and has a pair of opposite longitudinal edges, an inner face engaging the object, and an outer face turned outward away from the object. The support tape is of single-layer design and having a class D abrasion resistance according to LV 312-1. One closure strip of an adhesive compound extends along one of the faces at one of the edges, and another closure strip of an adhesive compound extends parallel to the edges, along the other face, and transversely offset on the other face from the one closure strip. It is adhered to the one closure strip. A fixing strip of an adhesive compound extends longitudinally on the inner face, offset thereon from the one and other closure strips, and adheres the tape to the object.

### CROSS REFERENCE TO RELATED APPLICATIONS

This application is a division of U.S. patent application Ser. No. 16/647,903 filed 17 Mar. 2020 as the US-national stage of PCT application PCT/EP2018/080973 filed 12 Nov. 2018 and claiming the priority of German patent application 202017107748.9 itself filed 20 Dec. 2017.

### FIELD OF THE INVENTION

The invention relates to a covering for encasing an elongated object, in particular for making an elongated sheath for cables in automobiles and to the combination of the covering and the elongated object.

### BACKGROUND OF THE INVENTION

Such a covering typically has a support tape and at least two closure strips of an adhesive compound and on an upper face and/or lower face of the support tape, the closure strips extending along respective longitudinal edges of the support tape and defining a free area between and/or next to one another.

Coverings for encasing an elongated object are used and implemented, for example, to enclose in particular cables, lines, and possibly plugs in automobiles and protect them from abrasion stress, for example. In fact, not only electrical cables, but also hoses and pipes in general may be wrapped using such coverings and casings or longitudinal enclosures thus produced. In some cases, terminal devices may likewise be protected and held together by the wrapping.

In the prior art, a large variety of procedures are followed in making such casings or elongated enclosures. Thus, for example, in EP 1 875 573 [U.S. Pat. No. 7,132,028] the sheath is made up of two adhesive tapes, with a third adhesive tape being applied to the sheath. As a result, the covering implemented in this way has a relatively complicated design and is also difficult to manufacture.

In a method for encasing an elongated object according to DE 101 49 071 [U.S. Pat. No. 6,936,553], a covering is provided with a self-adhering adhesive tape. The adhesive tape is adhered to the covering in such a way that the adhesive tape extends beyond one of the longitudinal edges of the coverings. In addition, the textile covering and the adhesive tape have one or more tear lines running essentially at right angles to the longitudinal direction so that the sheath may be easily torn by hand.

For the reasons described above it is of primary importance to provide abrasion protection for such coverings, and casings or elongated enclosures produced therefrom. Therefore, special demands with regard to abrasion resistance are imposed on the support tape. To this end, in the prior art according to DE 20 2012 103 975 [U.S. Pat. No. 10,351,734], for example, a technical adhesive tape with high abrasion resistance is disclosed that is provided with a strip-shaped double-layer support tape. The double-layer support tape is composed of textile layered plies, each designed as a woven fabric. The two woven fabrics are coupled to one another via an adhesively bonded layer, and as a whole define a laminate. The overall abrasion resistance is thus increased, although in this case as well the complexity of manufacture is considerable.

A generic covering according to DE 20 2010 014 239 [US 2013/0273333] relates to an adhesive tape and a sheath made from same. The adhesive tape is provided with a support tape and one or more adhesive strips that are applied to the support tape. The adhesive strip covers between approximately 20% and 50% of the surface area of the associated support tape face. Thus, although an adhesive tape is provided that allows particularly flexible winding on objects to be combined with one another, in particular cables, there is no information concerning abrasion resistance, and further improvements here are still possible.

### OBJECT OF THE INVENTION

The object of the present invention is to refine such a covering for encasing an elongated object in such a way that high abrasion resistance, and at the same time low manufacturing costs, are achieved.

Another object is to provide an improved system comprising the elongated object and a covering according to the invention.

### SUMMARY OF THE INVENTION

To achieve this technical object, a generic covering according to the invention is characterized in that the support tape has a single-layer design and has at least a class D abrasion resistance according to LV 312-1 (2009).

As described above, the covering according to the invention is used to sheath or longitudinally enclose an elongated object. An elongated sheath for cables in automobiles is preferably provided. To allow control of chafing and abrasion stresses that are observed here, for example in the interior of an engine compartment, the invention relies on the one hand on a support tape having a single-layer design, and on the other hand, a support tape that is provided with a class D abrasion resistance according to LV 312-1 (2009).

The above-referenced LV 312-1 standard from 2009 is in fact a test specification that determines the abrasion resistance in accordance with DIN ISO 622. For this purpose, the covering or its strip-shaped support tape to be examined is initially adhesively bonded to a mandrel or metal rod having a diameter of 5 mm. Using a scraping tool having a needle diameter of 0.45 mm, the number of strokes necessary to wear through the adhesive tape or the support tape is then determined, taking into account a weight force of 7 N. The greater the number of strokes, the more abrasion-resistant the design of the adhesive tape in question.

In practice, a distinction is made between abrasion class A that offers no abrasion protection due to the number of strokes being less than 100, to class E that provides high abrasion protection. This corresponds to 5000 strokes and greater.

According to the invention, a support tape is now required that meets at least abrasion class D according to the above-described standard, i.e., does not (yet) wear through, taking into account 1000 to 4999 strokes. If abrasion class E is achieved, even 5000 to 14,999 strokes are recorded without wearing through. Abrasion class D corresponds to “high abrasion protection,” while class E provides “very high abrasion protection.”

According to the invention, this high or very high abrasion resistance is achieved and provided using a support tape expressly having a single-layer design, i.e. not made up of two layered plies as in the prior art according to DE 20 2012 103 975. In particular, according to the invention textile support tapes having a weight per unit area of 30 g/m² to 300 g/m² are routinely used as a single-layer support tape. The weight per unit area is generally at least 100 g/m² in order to provide the required abrasion protection.

Furthermore, the textile support tape is advantageously a woven fabric, a nonwoven fabric, or a knitted fabric. The single-layer support tape is generally designed as a one-ply textile layer made of a woven fabric.

To achieve the required abrasion resistance, the advantageously used textile support tape is made of polyester fibers and/or polyamide fibers. The polyester fibers or polyamide fibers, or generally suitable fibers of the textile support tape, are typically used for manufacture of threads that, in particular as warp and weft threads, are then used as support tapes in the advantageously used fabric.

To increase the abrasion resistance in this regard, the threads of the textile support tape are generally textured. The texturing generally refers to a procedure in which the threads are permanently crimped. The crimping creates loops that increase the elastic resilience and also the abrasion resistance.

Common texturing processes such as the false twist method may be used. Blow texturing is also possible in principle. In addition, the threads of the textile support tape used may also be intermingled. Intermingling or also interlacing refers to supplementary finishing of the threads, in which they are intertwined at certain points by turbulence using air.

However, apart from these measures for increasing the abrasion resistance, it is alternatively and additionally possible to chemically and/or physically consolidate the support tape or textile support tape. Chemical consolidation typically takes place by introducing a binder. Physical consolidation is possible in such a way, for example, that for a nonwoven fabric that is used, the nonwoven fabric is additionally needled. This may also include introduction or application of sewing threads for such a nonwoven fabric. In any case, numerous methods and procedures exist in the prior art for providing the described support tape and in particular textile support tape with the required abrasion resistance of at least class D according to LV 312-1, in particular even when the support tape has a single-layer design, or, as in the present case, only one woven fabric layer or only one nonwoven fabric layer is used as the support tape.

For example, stitched nonwoven support tapes having a weight per unit area of 230 g/m² may be implemented that in particular have a design as described in DE 20 2014 106 246 and have abrasion class D. Also suitable are available woven fabric support tapes of abrasion class D, such as those described in DE 20 2016 102 701 [US 2019/0148032] by the present applicant. In any case, such support tapes are basically available, and may be used and implemented according to the invention to achieve the particular covering.

The particular closure strip is generally formed from an adhesive compound of the hot-melt type. Alternatively or additionally, a viscoelastic adhesive compound may be used for implementing the closure strip. The particular adhesive strip or closure strip based on a hot-melt adhesive, for example, as the adhesive compound may be produced in a particularly simple manner by applying the adhesive compound in question to the support tape in the nozzle application process. Two adhesive strips may thus be advantageously provided, also with a matching width, in a particularly simple manner.

The width of the closure strip or adhesive strip is generally approximately 10% to 30% of the width of the support tape. In addition, the closure strip is usually provided with a strip coating weight of 50 g/m² to 150 g/m². In addition to the two mandatory closure strips on the upper face/lower face of the support tape, a further, third adhesive strip is also generally provided. This third adhesive strip generally functions as a fixing strip. In addition, the third adhesive strip, viewed in the cross section of the support tape, is situated in the free area between and/or next to the two above-mentioned closure strips or adhesive strips. In one variant it has also proven suitable when the third adhesive strip is situated mirror-symmetrically with respect to a central axis of the support tape.

The subject matter of the invention further relates to an elongated object encased by a covering having the above-described design. To produce the casing, the covering is fixed to the elongated good in the axial direction via one closure strip. The other closure strip may be fixed to the outer face of the support tape, for example, to form a closure. Alternatively, a procedure may be followed in which the covering is initially fixed to the elongated good in the axial direction via the third adhesive strip or fixing strip. Both closure strips are subsequently adhesively bonded to one another to form a closure and a wrapping.

### BRIEF DESCRIPTION OF THE DRAWING

The invention is explained in greater detail below with reference to the drawings that illustrate one embodiment. In the figures:

FIG. 1 shows a first embodiment of the covering according to the invention,

FIG. 2 shows the covering according to one alternative,

FIG. 3 shows another alternative embodiment of the covering,

FIG. 4 shows encasing of an elongated object using the covering according to FIG. 1,

FIG. 5 shows encasing of the elongated good, using the covering according to FIG. 2, and

FIG. 6 shows encasing by using the covering illustrated in FIG. 3.

### SPECIFIC DESCRIPTION OF THE INVENTION

The drawing shows a covering that is used for encasing an elongated object 1. The elongated good 1 includes, for example, but is not limited to, cables, lines, pipes, or also plug-in connectors, terminal devices, etc., that generally extend in the interior of an automobile and that are to be combined by the covering. In addition, the covering in this regard typically provides for abrasion protection. In particular, by use of the covering described in greater detail below, the elongated good 1 is encased in the longitudinal or axial direction so that overall an elongated sheath 2 of the elongated good 1 is thus provided as shown in sectional views in FIGS. 4, 5, and 6.

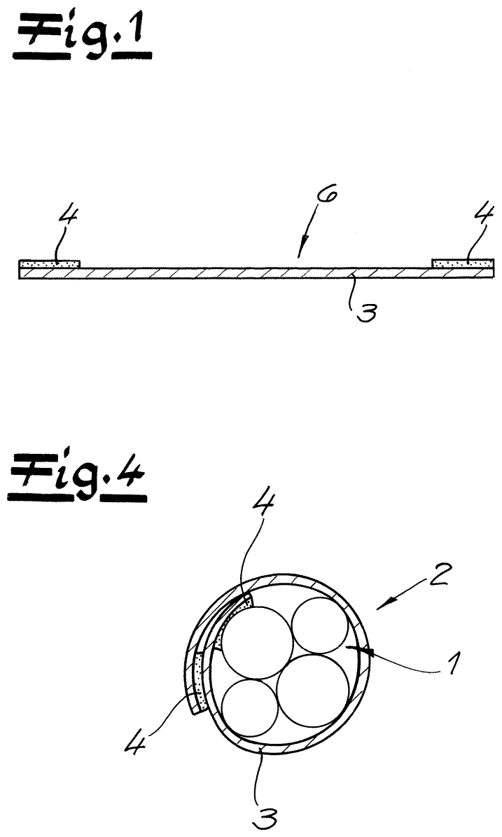

On the one hand, the covering as such is shown in detailed sectional views in FIGS. 1, 2, and 3. In particular, the covering is made up essentially of a support tape 3 and at least two closure or adhesive strips 4 that are applied to the support tape 3. The closure strips or adhesive strips 4 are produced from an adhesive compound.

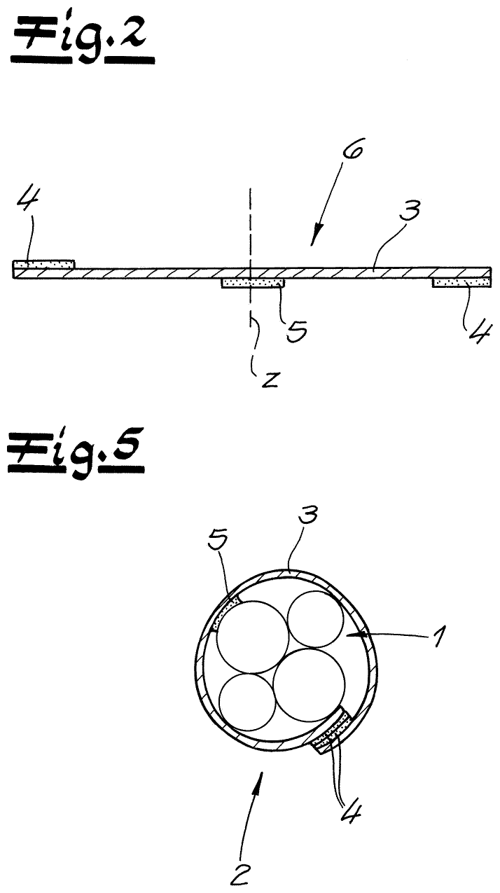

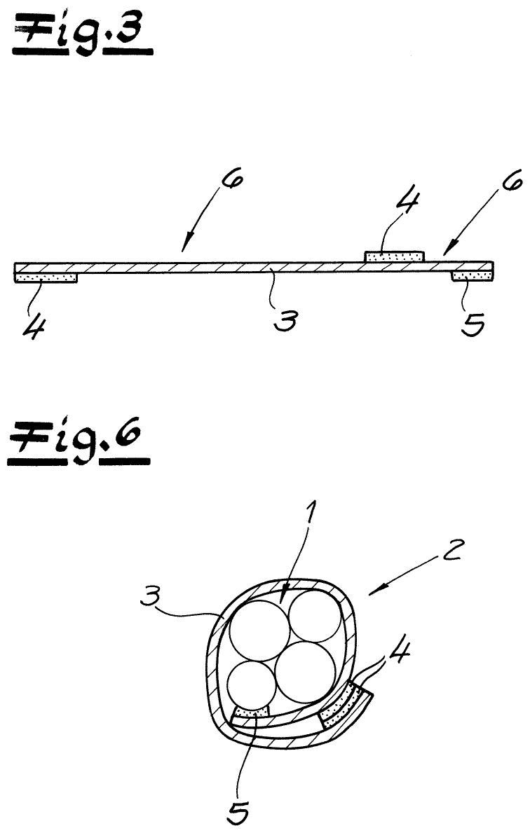

The closure strips 4 may both be placed on an upper face of the support tape 3, as shown in the embodiment according to FIG. 1. In the variants according to FIGS. 2 and 3 the two closure strips 4 are on the upper face of the support tape 3 on the one hand, and on the lower face of the support tape 3 on the other hand. The support tape 3 is a strip as illustrated in FIGS. 1 through 3 in cross section, the same as the closure strips 4. The two closure strips 4 each extend along respective longitudinal edges of the support tape 3 or at a specified spacing therefrom and parallel thereto. In the embodiments according to FIGS. 1 and 2, the closure strips 4 each adjoin associated support tape edges in lateral flush alignment. This also applies to the left closure strip 4 in the variant according to FIG. 3, whereas according to this embodiment the right closure strip 4 lies at a spacing from the support tape edge and parallel thereto. In addition, the two closure strips 4 define a free area 6 between one another in variants 1 and 2. The embodiment according to FIG. 3 even has two free areas 6, on the one hand between the two closure strips 4 and on the other hand next to the two closure strips 4.

In the variant according to FIG. 2, a third adhesive strip 5 that in the present case is a fixing strip 5 is situated in the free area 6 between the two closure strips 4. In the embodiment according to FIG. 3, the adhesive strip or fixing strip 5 in question is situated next to the two closure strips 4, in the present case next to the right closure strip 4, in the free area 6 at that location. This is discussed in greater detail below. Each of the two closure strips 4 not only extends along the longitudinal edges of the strip-shaped support tape 3, but is also applied to the support tape 3 without an overhang. That is, the two closure strips 4 are situated in flush alignment on the respective longitudinal edge, i.e. the longitudinal edge of the support tape 3, or extend at a constant spacing therefrom and parallel thereto. This applies according to the embodiment, but is not mandatory. The third adhesive strip or fixing strip 5 is also applied to the support tape 3 without an overhang.

According to the invention, the strip-shaped, elongated support tape 3 now has a single-layer design. In addition, the support tape has a class D abrasion resistance according to LV 312-1 (2009). In the present case, the support tape 3 is a textile support tape provided with a weight per unit area in the range of 30 g/m² to 300 g/m². According to the embodiment, the textile support tape 3 is a woven fabric.

In this regard, in particular a woven fabric made of polyester threads and/or polyamide threads is used. The particular polyester or polyamide threads are made of polyester or polyamide fibers. The threads of the woven fabric in question may also be textured and/or intermingled to increase the abrasion resistance of the described covering or of the strip-shaped support tape 3 as described above.

The closure strip 4 or the two adhesive strips 4 and also the fixing strip or third adhesive strip 5 are in each case strips whose adhesive compound is produced using a hot-melt adhesive. In particular, common UV-curable acrylate adhesives may be used. Alternatively or additionally, it is also possible to use a viscoelastic adhesive compound for implementing the two adhesive strips 4 as well as the third adhesive strip 5.

The manufacture of the closure strips 4 and of the fixing strip 5 generally takes place using a nozzle process by applying a hot-melt adhesive. As a result, all of the adhesive strips 4, 5 typically are of the same width. The width of the particular adhesive strip 4, 5 may be in the range of approximately 10% to 30% of the width of the support tape. In the invention, a strip coating weight of 50 g/m² to 150 g/m² is recommended for the adhesive strips 4, 5.

As stated above, the third adhesive strip or fixing strip 5 is between or next to the two closure strips 4 in the free area 6. In addition, in the embodiment according to FIG. 2 the third adhesive strip or fixing strip 5 is situated and oriented mirror-symmetrically with respect to a central axis Z of the support tape 3, indicated in dashed lines in FIG. 2.

An overall elongated sheath 2 as illustrated in detail in FIGS. 4 through 6 may be implemented by use of the covering described above. The covering according to FIG. 1 is used to produce the elongated sheath according to FIG. 4. The covering in FIG. 1 is initially fixed once to the elongated good 1 in the axial direction via one of the two closure strips 4. The other closure strip 4 is then fixed to the lower face of the support tape 3 in the present case to form a wrapping. This is because the covering according to FIG. 1 is provided with two closure strips 4 on the upper face of the support tape 3.

As an alternative to the elongated sheath according to FIG. 4, an elongated sheath corresponding to the view in FIG. 5 may be provided and implemented. A covering as illustrated in FIG. 2 is used. In this case the covering is initially fixed to the elongated good 1 in the axial direction via the fixing strip, i.e., the third adhesive strip 5. The support tape 3 is then placed around the elongated good 1 on both faces so as to encircle it, thus providing the necessary wrapping. The closure of the support tape 3 by the closure strip 4 takes place in such a way that the two closure strips 4 are adhesively bonded to one another. Of course, this is not mandatory, and the two closure strips 4 could also be fixed next to and at a spacing from one another on the lower face or upper face, respectively, of the support tape 3.

A procedure comparable to that for the elongated sheath according to FIG. 5 is used to produce the elongated sheath according to FIG. 6. In this case, however, the covering according to FIG. 3 is used. Here, in a similar manner the covering in question according to FIG. 3 is initially fixed to the elongated good 1 in the axial direction via the fixing strip, i.e., the third adhesive strip 5. The support tape 3 is then placed around the elongated good 1 on both faces so as to encircle it, thus providing the necessary wrapping, in which the closure of the support tape 3 is effected by the closure strips 4 that are adhesively bonded to one another. In principle, however, the two closure strips 4 may also be fixed next to and at a spacing from one another on the lower face or upper face, respectively, of the support tape 3. In this case as well, the covering in question is initially fixed to the elongated good 1 in the axial direction via the fixing strip, i.e. the third adhesive strip 5. The support tape 3 is then wrapped around the elongated good 1 on both faces so as to encircle it, thus providing the necessary wrapping, in which the closure of the support tape 3 takes place by the closure strips 4 that are adhesively bonded to one another.

We claim:

1. In combination:
an elongated object;
a support tape extending longitudinally along the object, wrapped around and encasing the object, and having a pair of opposite longitudinal edges, an inner face engaging the object, and an outer face turned outward away from the object, the support tape being of single-layer design and having a class D abrasion resistance according to LV 312-1;
one closure strip of an adhesive compound extending along one of the faces at one of the edges;
another closure strip of an adhesive compound extending parallel to the edges, along the other face, transversely offset on the other face from the one closure strip, and adhered to the one closure strip; and
a fixing strip on the inner face, offset thereon from the one closure strip and other closure strip, and adhering the tape to the object, the fixing strip or the other closure strip extending along the other of the edges.

2. The combination according to claim 1, wherein the support tape is a textile support tape having a weight per unit area of 30 g/m² to 300 g/m².

3. The combination according to claim 2, wherein the textile support tape is a woven fabric, nonwoven fabric, or knitted fabric.

4. The combination according to claim 2, wherein the textile support tape is made of polyester fibers and/or polyamide fibers.

5. The combination according to claim 4, wherein threads produced from the polyester fibers and/or polyamide fibers are textured.

6. The combination according to claim 5, wherein the threads are intermingled.

7. The combination according to claim 1, wherein the support tape is chemically and/or physically consolidated.

8. The combination according to claim 1, wherein the adhesive compound for the closure strip is a hot-melt adhesive and/or a viscoelastic adhesive.

9. The combination according to claim 1, wherein the closure strips are of the same width.

10. The combination according to claim 1, wherein a width of the closure strip is approximately 10% to 30% of a width of the support tape.

11. The combination according to claim 1, wherein the closure strip has a strip coating weight of 50 g/m² to 150 g/m².

12. The combination according to claim 1, wherein the fixing strip in cross section is in a free area between the closure strips.

13. The combination according to claim 13, wherein the fixing strip is situated mirror-symmetrically with respect to a center line of the support tape.

14. The combination according to claim 1, wherein the fixing strip is along the other of the edges on the other face.
